(19) United States
(12) Patent Application Publication
(10) Pub. No.: US 2003/0231558 A1
(43) Pub. Date: Dec. 18, 2003

(54) Timepiece

(76) Inventor: Hisao Nakamura, Chiba-shi (JP)

Correspondence Address: ADAMS & WILKS, 31st Floor, 50 Broadway, New York, NY, 10004, US

(21) Appl. No.: 10/446,923

(22) Filed: May 28, 2003

(30) Foreign Application Priority Data
May 30, 2002 (JP) 2002-156882

(51) Int. Cl. G04B 37/00

(52) U.S. Cl. 368/309

(57) ABSTRACT

To stably fix a module to a case having a one-piece structure and thin a thickness between an inner side face and an outer side face of the case. A fitting projected portion is a projection in a tapered shape spreading to a side of cover glass and provided at a portion of an elastically deformed portion in a shape of a two ends supporting beam integrally formed to a first housing made of resin. According to the elastically deformed portion in the shape of the two ends supporting beam, when a module is integrated to a containing portion of a case, the fitting projected portion is pressed by an inner side face of the case and therefore, planarly deformed in a direction of a center of the case. Further, when the elastically deformed portion in the shape of the two ends supporting beam deformed in this way is recovered to an original shape when the fitting projected portion is fitted to an engaging recessed portion. Thereby, the module is contained and stably fixed to the containing portion of the case having a one-piece structure integrated with a case band and a case back.

### BACKGROUND OF THE INVENTION

The present invention relates to a module fixing structure of a timepiece for integrating and fixing a module to a case having a one-piece structure integrated with a case band and a case back from an opening portion for containing the module on a side of cover glass.

A timepiece containing and fixing a module to a case having a one-piece structure integrated with a case band and a case back, that is, a case formed with an opening portion for containing the module on a side of cover glass is provided with an advantage in which a structure thereof is simple and waterproof seal may be provided between the cover glass and the case in comparison with a timepiece in which a case band and a case back are separated from each other and a module is contained and fixed to a case formed with opening portions for both of a side of a cover glass and a side of a case back. However, according to the former module fixing structure, the contained module needs to hold and fix at a bottom face or an inner side face of the case and therefore, the former is more complicated than the latter.

That is, according to a module fixing structure disclosed in JP-H02-93790-U a stepped portion is formed on an upper side of an inner side wall of a case formed by resin and the stepped portion is formed with a plurality of pieces of projections projected upwardly. Meanwhile, a module is formed with a flange portion at side face thereof. When the module is integrated to the case, a lower face of the flange portion is arranged to be brought into contact with the stepped portion. Further, the projections are fixed to the flange portion by thermal calking to thereby hold and fix the contained module at an inner side face of the case.

Owing to such a fixing structure, the module is stably fixed to the case. However, there poses a problem that according to such a fit-to-set fixing structure, the module cannot be removed from outside. Further, the case is formed with the stepped portion brought into contact with the lower face of the flange portion of the module and therefore, a thickness between the inner side face and an outer side face of the case is increased by an amount of the stepped portion and therefore, there poses a problem that the case becomes large-sized and cannot be adopted for a small-sized timepiece.

Next, there is a module fixing structure disclosed in JP-H09-189776 formed with at least two recessed portions at an inner side face of a case formed by resin. Further, the recessed portion is provided with a ceiling face. Meanwhile, a module is formed with hook portions projected outwardly from a side wall portion thereof and formed with at least two cantilever type hook portions bent to an inner diameter direction of the module. Further, the cantilever type hook portion is of a shape constituting a ceiling face engaging portion engaged with the ceiling face of the recessed portion by a portion of an upper end face of a movable end portion thereof. When the module is integrated to the case, the cantilever type hook portion is bent to the inner diameter direction by being brought into contact with the inner side face of the case, however, when the module is contained at a predetermined position, the cantilever type hook portion recovers to an original shape by elasticity in an outer diameter direction and fitted to the recessed portion of the inner side face of the case to thereby hold and fix the contained module at the inner side face of the case.

Owing to such a fixing structure, the module is fixed to the case. However, the module is formed with the hook portions projected outwardly from the side wall portion and formed with at lease the two cantilever type hook portions bent to the inner diameter direction of the module and therefore, a thickness between the inner side face and the outer side face of the case is increased and therefore, there poses a problem that the case becomes large-sized and cannot be adopted for a small-sized timepiece. The increased thickness in this case is constituted by a total of the hook portion and therefore, a total of at least a thickness of an upper end portion of the movable end potion of the cantilever type hook portion and an amount of bending the movable end portion to the inner diameter direction.

Meanwhile, the module fixing structure disclosed in JP-H09-189776 is not a fit-to-set fixing structure and therefore, the module can be removed from outside. That is, a portion of the upper end face of the movable end portion of the cantilever type hook portion is formed with the ceiling face engaging portion for engaging with the ceiling face of the recessed portion and formed with a hook off portion. The movable end portion of the cantilever type hook portion is bent to the inner diameter direction by inserting an engagement releasing jig from a knotched portion formed at the case and pressing the jig to the hook off portion or making the hook off portion catch the jig. Then, fitting of the cantilever type hook portion and the recessed portion is released and the module can be removed from the case to outside.

However, since the hook portion is the cantilever type hook portion, when the movable end portion is repeatedly bent, the hook portion cannot be recovered to the original shape by reducing the elasticity by plastic deformation and there poses a problem that the module cannot firmly be fixed to the case by fitting. Therefore, there poses a problem that it is difficult to stably fix the module to the case, detachment of the fitting is brought about when a product is dropped, or the module is inclined after having been integrated. Further, since the portion of the upper end face of the movable end portion of the cantilever type hook portion is formed with the ceiling face engaging portion for engaging with the ceiling face of the recessed portion and formed with the hook off portion, a housing of the module is constituted by a considerably complicated shape and therefore, there also poses a problem that the cost of a die for fabricating the housing by resin molding becomes necessarily increased.

A problem to be resolved by the invention is to provide a module fixing structure for stably fixing a module to a case having a one-piece structure and making a thickness between an inner side face and an outer side face of the case thinner than that of a conventional timepiece of this type.

### SUMMARY OF THE INVENTION

In order to resolve the above-described problem, in a timepiece comprising a case integrated with a case band and a case back and having an opening portion for containing a module on a surface side, a module having a housing made of a resin and contained in the case and cover glass for covering the opening portion of the case, the module is fixed to the case by fitting the fitting projected portions formed at portions of elastically deformed portions in a shape of a two ends supporting beam integrally formed at a side face of the housing and deformed in a planar direction to a plurality of engaging recessed portions formed at an inner side face of the case.

Fitting of the fitting projected portions and its corresponding engaging recessed portions is carried out at at least three locations spaced apart from each other by predetermined intervals so that housing does not incline inside the case. Or, fitting of the fitting projected portions and its corresponding engaging recessed portions achieves an inclination preventing operation of the housing and carried out at at least two locations opposed to each other.

The fitting projected portion is a projection in a tapered shape spreading to a side of the cover glass and the module is made to be smoothly integrated to the case from an only opening portion.

Fitting projected portion is formed in a shape of an inverse cone and only an apex of a circular arc is brought into contact with the inner side face of the case when integrated. Therefore, an elastically deformed portion of the housing in containing a movement is smoothly deformed and a performance of integrating the movement to the case is promoted.

Further, a module removing recessed portion is provided at a face of the fitting projected portion on a side of the cover glass. The module is made to be able to remove from the case by deforming the elastically deformed portion of the housing to an inner diameter direction by pressing a fitting releasing jig to the recessed portion from outside of the case.

### BRIEF DESCRIPTION OF THE DRAWINGS

A preferred embodiment of the invention will now be described with reference to the accompanying drawings wherein:

FIG. 1 is a disassembled perspective view of a timepiece according to an embodiment of the invention;

FIG. 2 is a plane view of the timepiece according to the embodiment of the invention;

FIG. 3 is a sectional view of the timepiece according to the embodiment of the invention; and

FIG. 4 is a partial sectional view cut by a line X-X of FIG. 2.

### DETAILED DESCRIPTION OF THE PREFERRED EMBODIMENTS

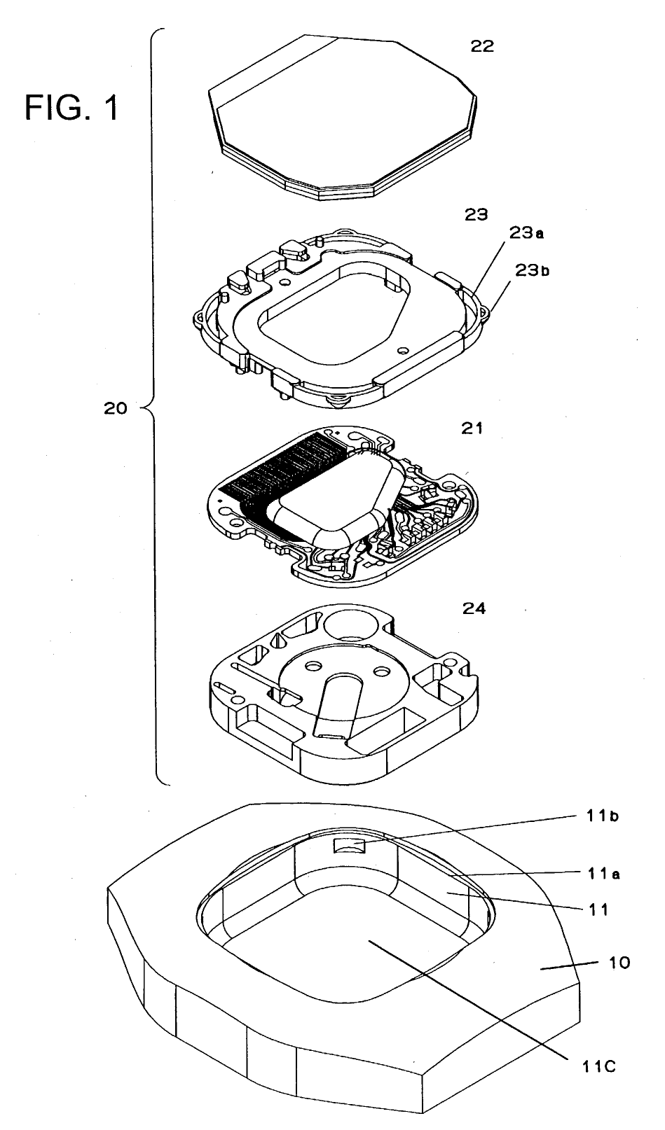

According to a timepiece of an embodiment of the invention, as shown by a disassembled view in FIG. 1, a module 20 is fixed to a case 10 by fitting the fitting projected portions 23b formed at a side face of a housing made of a resin constituting a portion of the module 20 to a plurality of engaging recessed portions 11b formed at an inner side face 11 of the case 10 having a one-piece structure integrated with a case band and a case back. The housing made of resin comprising a first housing 23 and a second housing 24 is for containing or attaching constituent parts of the module 20. In FIG. 1, the fitting projected portion 23b formed at the side face of the housing made of resin is provided at a portion of an elastically deformed portion 23a in a shape of a two ends supporting beam formed integrally with the first housing 23 and deformed in a planar direction.

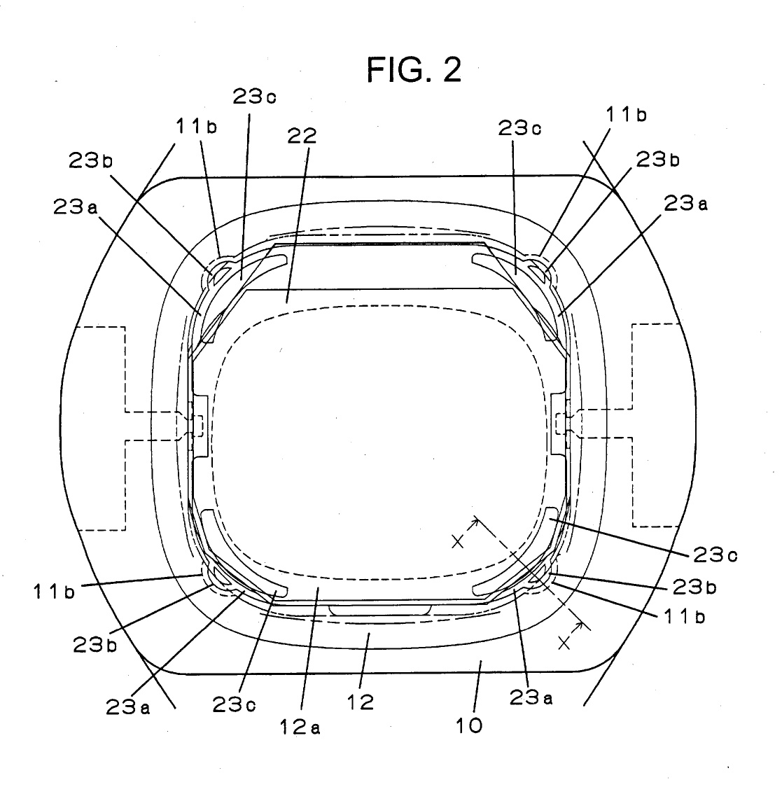

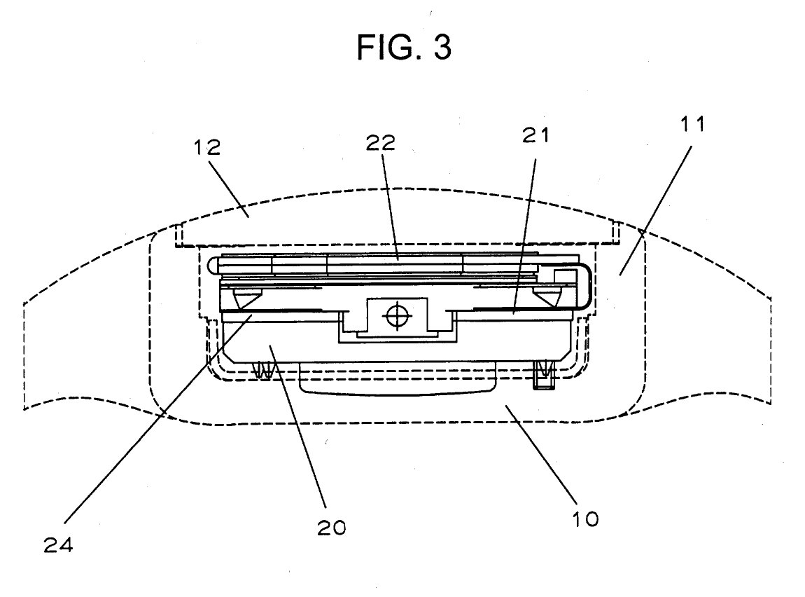

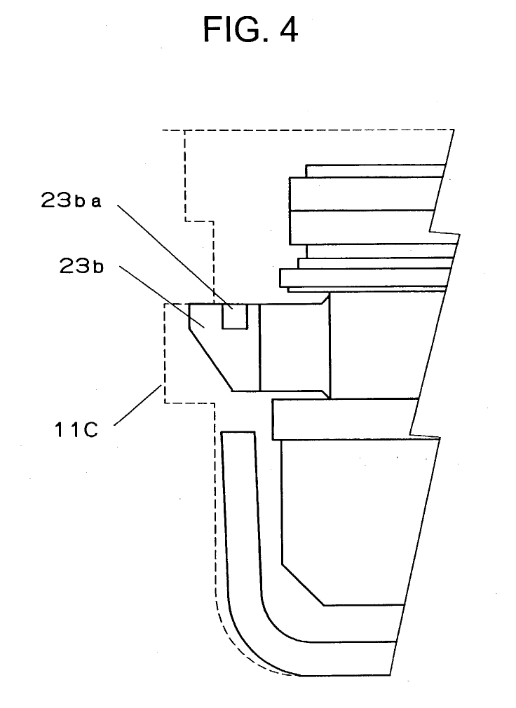

That is, as shown by the disassembled view in FIG. 1, a plane view in FIG. 2, a sectional view cut in a strap length direction in FIG. 3 and a partial sectional view in FIG. 4, respectively, the timepiece according to the embodiment of the invention is constituted by the case 10 integrated with the case band and the case back and having an only opening portion 11c on a surface side, the module 20 having the first housing 23 made of resin and contained in the case 10 and cover glass 12 for covering the opening portion 11c of the case.

Since the case 10 is the case having the one-piece structure integrated with the case band and the case back, a containing portion thereof for containing and fixing the module 20 is a one-bag-like containing portion. According to the timepiece of the embodiment of the invention, the one-bag-like containing portion is a cylindrical containing portion having the substantially rectangular opening portion 11c with four corners thereof in a circular arc shape. A plurality of the engaging recessed portions 11b are formed at an inner side face of the one-bag-like containing portion, that is, the inner side face 11 of the case 10. According to the timepiece of the embodiment of the invention, the plurality of engaging recessed portion 11b are formed by four pieces respectively at the four corners of the inner side face 11 of the case 10.

According to the timepiece of the embodiment of the invention, the module 20 is constituted by a circuit block 21, a liquid crystal display element 22, the first housing 23 and the second housing 24. The circuit block 21 is constituted by mounting various electronic parts constituting an electronic timepiece on a circuit board. The circuit block 21 held between a lower face of the first housing 23 and an upper face of the second housing 24 made of resin and the liquid crystal display element 22 electrically connected to the circuit block 21 is held on an upper face of the first housing 23. A planar shape of the module 20 successively laminated and integrated with the liquid crystal display element 22, the first housing 23, the circuit block 21 and the second housing constitutes the substantially rectangular module with the four corners in the circular arc shape.

The side face of the first housing 23 is provided with a plurality of pieces of the elastically deformed portion 23a in the shape of the two ends supporting beam deformed in the planar direction. According to the timepiece of the embodiment of the invention, the elastically deformed portions 23a of the shape of the two ends supporting beam are constituted by four pieces thereof and integrally formed with the housing by providing through holes 23c in a crescent shape at four corners of the first housing 23.

The fitting projected portion 23b is formed at a portion of the elastically deformed portion 23a of the shape of the two ends supporting beam. The fitting projected portion 23b is a projection in a tapered shape or a projection in a shape of an inverse cone spreading to a side of the cover glass 12, that is, the side of the opening portion 11c. By constituting such a shape, when the module 20 is integrated to the containing portion of the case 10, only an apex of a circular arc of the fitting projected portion 23b is brought into contact with the inner side face 11 of the case 10 and therefore, when the module is contained, the elastically deformed portion 23a is smoothly deformed and integrating performance is promoted.

A face of the fitting projected portion 23b on a side of the cover glass 12 is provided with a removing recess 23ba. There is a case of removing the module 20 temporarily contained in the case 10 from the case 10 depending on a situation of fabricating steps. At that occasion, the elastically deformed portion 23a in the shape of the two ends supporting beam is planarly deformed by touching a front end of an engagement releasing jig of a tweezers or the like to the removing recess 23ba to thereby release the fitting between the fitting projected portion 23b and the engaging recessed portion 11b.

A procedure of containing and stably fixing the module 20 to the case 10 will be explained as follows. According to the embodiment of the invention, the module 20 is constituted by holding the circuit block 21 shown by the disassembled view in FIG. 1 between the first housing 23 and the second housing 24 made of resin and integrating the liquid crystal display element 22 to the circuit block 21.

When the module 20 is moved down to integrate the module 20 constituted in this way from the side of the cover glass 12 into the case 10, the highest position of the inner side face 11 of the case and the fitting projected portion 23b provided at the first housing 23 made of resin are brought into contact with each other. When force of pressing the module 20 to the lower side is further exerted from the state, the fitting projected portion 23b in the tapered shape spreading to the side of the cover glass 12 is exerted with a force planarly directed to the center of the case to thereby planarly deform the elastically deformed portion 23a in the shape of the two ends supporting beam formed at the first housing made of resin. Then, an amount of extruding the fitting projected portion 23b formed at the portion of the elastically deformed portion 23a in the shape of the two ends supporting beam from an outer periphery of the module 20 is reduced.

By continuing to press further, the module 20 sinks to a side opposed to the cover glass 12 and at the same time, the fitting projected portion 23b moves toward the center of the case 10. When an outermost periphery of the fitting projected portion 23b coincides with the inner side face 11 of the case 10, planar deformation of the elastically deformed portion 23a in the shape of the two ends supporting beam is stopped and the first housing 23 is moved along the inner side face 11 of the case.

When a predetermined sectional moving amount is reached, the fitting projected portion 23b reaches the engaging recessed portion 11b provided at the inner side face 11 of the case, the elastically deformed portion 23a returns to the original shape by the elasticity and also the fitting projected portion 23b is settled to a position on an outer side of the outer periphery of the module 20.

As described above, when the module 20 is integrated to the containing portion of the case 10, the elastically deformed portion 23a in the shape of the two ends supporting beam is planarly deformed in the direction of the center of the case 10 since the fitting projected portion 23b is pressed by the inner side face 11 of the case 10. Since the elastically deformed portion 23a is constituted by a structure of the two ends supporting beam, a deformation amount thereof can be made larger than that of the conventional fitting projection having the cantilever structure. This signifies that a fitting amount when elastic deformation is released and the fitting projected portion and the engaging recessed portion are fitted to each other is increased.

Therefore, when the module 20 is integrated to the containing portion of the case 10, it is extremely easy to deform the elastically deformed portion 23a such that an outer peripheral face of the module 20 and the apex of the fitting projected portion 23b coincide with each other. Further, when the elastically deformed portion 23a in the shape of the two ends supporting beam formed in this way returns to the original shape when the fitting projected portion 23b is fitted to the engaging recessed portion 11b. Thereby, the module 20 is contained and stably fixed to the containing portion of the case 10 having the one-piece structure integrated with the case band and the case back.

Meanwhile, as is apparent from the plane view of FIG. 2, according to the invention, the module 20 is stably fixed to the case 10 having the one-piece structure and the thickness between the inner side face and the outer side face of the case 10 is thinner than that of the conventional timepiece of this type. This is because the module fixing structure according to the invention is constituted by the plurality of engaging recessed portions 11b formed at the inner side face 11 of the case 10 and the fitting projected portions formed at the outer periphery of the housing 23 made of resin of the module 20 which are the fitting projected portions 23b formed at portions of the elastically deformed portions 23a in the shape of the two ends supporting beam formed integrally with the outer periphery of the housing 23 made of resin. In this way, the amount of projection from the housing made of resin to the outer periphery is constituted only by the amount of projecting the fitting projection 23b to be fitted to the engaging recessed portion 11b provided at the inner side face of the case 10 and therefore, special means for concealing a total of the hook portion constituting the fitting portion, for example, concealing the outer periphery of the module by a dial or a bezel which has been needed in the conventional timepiece of this kind, is dispensed with. Incidentally, according to the plane view of FIG. 2, the concealment of the fitting portion is realized by making an outer peripheral face of a display face 12a of the cover glass 12 opaque, however, the opaque portion is much smaller than that in the conventional timepiece. In this way, according to the invention, the module 20 can be contained and stably fixed to the containing portion of the case 10 without covering the outer periphery of the module 20.

Further, in FIG. 1 and FIG. 2, there is provided the module fixing structure having four sets of portions of fitting the engaging recessed portion 11b and the fitting projected portions 23b, however, a module fixing structure having three sets of the fitting positions can be constituted. Further, the module fixing structure can also be realized by two sets of the fitting portions by constituting a structure in which the module 20 is not inclined to the case 10. The module fixing structure achieving the inclination preventing operation is a structure in which, for example, two sets of the portions of fitting the engaging recessed portions 11b and the fitting projected portions 23b are provided at positions symmetrical with each other relative to a center point of the case and a fitting area thereof is extended in a circumferential direction.

Further, the module 20 includes not only an electronic timepiece module having a liquid crystal display element but also a movement of a mechanical timepiece or an electromechanical timepiece.

The invention can provide a module fixing structure which is a module fixing structure for solidly and stably fixing a module to a case in a timepiece integrating and fixing the module from an opening portion for containing the module on a side of cover glass in the case having a one-piece structure integrated with a case band and a case back and a module fixing structure making a thickness between an inner side face and an outer side face of the case considerably thinner than that of the conventional timepiece of this type. Therefore, in the case of a timepiece having a display face the same as that of a conventional timepiece of this type, small-sized formation of the case and small-sized formation of the timepiece can be realized. Further, in the case of a timepiece having a case of a size the same as that of a conventional timepiece of this type, large-sized formation of a display face can be realized.

According to a module fixing structure of the invention, a module is fixed to a case by fitting the fitting projected portions formed at portions of elastically deformed portions in a shape of a two ends supporting beam integrally formed at a side face of the housing made of resin for holding the module and deformed in a planar direction to a plurality of engaging recessed portions formed at an inner side face of the case having a one-piece structure integrated with a case band and a case back. Therefore, fabrication cost of the housing is considerably reduced in comparison with that of a conventional module fixing structure having an elastically deformed portion in a cantilever shape of this type.

Further, since the elastically deformed portion formed with the fitting projected portion at a portion thereof is an elastically deformed portion in a shape of a two ends supporting beam type deformed in a planar direction, in comparison with an elastically deformed portion in the cantilever shape adopted in a conventional module fixing structure of this type, a stable fitting projected portion which is difficult to the deformed plastically can be realized. Further, an amount of deforming the elastically deformed portion becomes larger than that of the elastically deformed portion in the cantilever shape adopted in the conventional module fixing structure of this type and therefore, integration or removal of the module is carried out more smoothly.

What is claimed is:

1. A timepiece comprising:
a case integrated with a case band and a case back and having an opening portion for containing a module on a surface side;
a module having a housing made of a resin and contained in the case; and
a cover glass for covering the opening portion of the case, wherein the module is fixed to the case by fitting fitting projected portions formed at portions of elastically deformed portions in a shape of a two ends supporting beam integrally formed at a side face of the housing and deformed in a planar direction to a plurality of engaging recessed portions formed at an inner side face of the case.

2. A timepiece according to claim 1, wherein fitting of the fitting projected portions and its corresponding engaging recessed portions is carried out at at least three locations spaced apart from each other by predetermined intervals.

3. A timepiece according to claim 1, wherein fitting of the fitting projected portions and its corresponding engaging recessed portions achieves an inclination preventing operation of the housing and carried out at at least two locations opposed to each other.

4. A timepiece according to claim 1, wherein the fitting projected portion is a projection in a tapered shape spreading to a side of the cover glass.

5. A timepiece according to claim 1, wherein the fitting projected portion is formed in a shape of an inverse cone.

6. A timepiece according to claim 1, wherein a module removing recessed portion is provided at a face of the fitting projected portion on a side of the cover glass.
